(19) United States
(12) Patent Application Publication
(10) Pub. No.: US 2014/0358556 A1
(43) Pub. Date: Dec. 4, 2014

(54) AUDIO DECOMPRESS PROGRAM

(71) Applicant: Lloyd Trammell, Thousand Oaks, CA (US)

(72) Inventor: Lloyd Trammell, Thousand Oaks, CA (US)

(73) Assignee: Max Sound Corporation, La Jolla, CA (US)

(21) Appl. No.: 14/271,293

(22) Filed: May 6, 2014

Related U.S. Application Data
(60) Provisional application No. 61/821,065, filed on May 8, 2013.

(51) Int. Cl. G10L 21/038

(52) U.S. Cl. CPC G10L 21/038
USPC 704/500

(57) ABSTRACT

A method of decompressing audio comprises normalizing the over compressed audio at a percentage of 48. Next the audio is converted from 16 to 32 bit to allow the filter a better resolution source to process. The next step is processing the converted ausion with a Chebyshev filter, preferably with a range of 4 Hz to 22050 Hz (bandpass mode) at the order of 18 (@36 dB estimated. After the filter, the audio is converted back to 16 bit with the dither setting shown in the block. Now, the end result is a newly repaired piece of audio with the dynamic and harmonic content restored.

### CROSS-REFERENCE TO RELATED PATENT APPLICATIONS

Embodiments of the present invention relate to U.S. Provisional Application Ser. No. 61/821,065, filed May 8, 2013, entitled “DECOMPRESS VST PLUGIN”, the contents of which are incorporated by reference herein and which is a basis for a claim of priority.

### BACKGROUND OF THE INVENTION

Conventional storage mechanisms result in an overly compressed sound that has little to no dynamic range, in order to have the “loudest” available output on a playback device. This leaves the music very dull and lifeless to the listener. There has been a “Loudness War” for many years at the cost of music listening quality. At present time the only solution is to go back to the original “master recording” and remix, which is too costly and sometimes impossible, ort maybe just lower the amplitude and try to “remix using EQ techniques.

“Loudness war” or “loudness race” is the popular name given to the trend of increasing audio levels on CDs and in digital audio files over the last few decades, which many critics believe damages the sound and reduces listener's enjoyment. Increasing loudness was first reported with respect to “mastering practices for 7” singles. The maximum peak level of analog recordings such as these is limited by varying specifications of electronic equipment along the chain from source to listener, including vinyl record and cassette players.¹ ¹ http://en.wikipedia.org/wiki/Loudness_war

With the advent of the Compact Disc (CD), music is typically encoded to a digital format with clearly defined maximum peak amplitude. Once the maximum amplitude of a CD is reached, loudness can be increased still further through signal processing techniques such as dynamic range compression and equalization. Engineers can apply an increasingly high ratio of compression to a recording until it more frequently peaks at the maximum amplitude. In extreme cases, clipping and other audible distortion is introduced to increase loudness further. Modern recordings that use extreme dynamic range compression and other measures to increase loudness therefore can sacrifice sound quality to loudness. The competitive escalation of loudness has led music fans and members of the musical press to refer to the affected albums as “victims of the loudness war²”. ² See, n.1, Above.

As a result, conventionally recorded music often sound muddy, clipped and lack punch, which is largely due to the above discussed ‘loudness war’ that has been taking place in recording studios. To make a track stand out from the rest of the pack, recording engineers have been turning up the volume on recorded music. Louder tracks grab the listener's attention, and in this crowded music market, attention is important. And thus the loudness war—engineers must turn up the volume on their tracks lest the track sound wimpy when compared to all of the other loud tracks. However, there's a downside to all this volume. Our music is compressed. The “louds” are loud and the “softs” are loud, with little difference. The result is that our music seems strained, there is little emotional range, and listening to loud all the time becomes tedious and tiring.³ ³ http://www.youtube.com/watch?v=3Gmex_{—}4hreQ&noredirect=1; http://musicmachinery.com/2009/03/23/the-loudness-war/

Virtual Studio Technology (VST) is a software interface that integrates software audio synthesizer and effect plug-ins with audio editors and hard-disk recording systems. VST and similar technologies use digital signal processing to simulate traditional recording studio hardware in software. Thousands of plug-ins exist, both commercial and freeware, and a large number of audio applications support VST under license from its creator, Steinberg⁴. ⁴ http://en.wikipedia.org/wiki/Virtual_Studio_Technology

A new method and process is therefore required that addresses the above noted deficiencies of the conventional methods.

### SUMMARY OF THE INVENTION

The purpose of the inventive De-Compress technique is to resynthesize or recreate the missing harmonic content and an approximate amplitudes as the original may have possessed.

According to one exemplary embodiment, the inventive sound enhancement mechanism is a VST effect plug-in for use with audio editing programs that edit audio and support VST. The plug-in can replace dynamic and harmonic content in overly compressed files, such as Dance Music. Applications for this would be remixing of existing music, internet broadcast, terrestrial broadcast, or anything audio that needs to have the harmonic and dynamic ranges restored.

In one exemplary embodiment the audio signal can first be normalized, for example, to about 48%, this equates to about 6 dB when finished [Range 0 to 100%]. The audio signal will be converted to a higher bit rate, for example from 16 bit to 32 bit for increased dynamic range. The audio signal is preferably processed with a Chebyshev or other similar filter. The processed audio can then be converted back to a 16 bit. The audio is then processed with dithering.

According to an embodiment of the inventive method, first, the over compressed audio is normalized at a percentage of 48. Next, the audio is converted from 16 to 32 bit to allow the filter a better resolution source to process. The next step is processing the audio with a Chebyshev filter or a similar filter with a range of 4 Hz to 22050 Hz (bandpass mode) at the order of 18 (@36 dB estimated). (This step will resynthesize, or recreate the harmonic and dynamic information that was lost due to excessive audio compression.) After the filter, the audio is converted back to 16 bit with the dither setting shown in the block. Advantageously, the end result is a newly repaired piece of audio with the dynamic and harmonic content restored.

### BRIEF DESCRIPTION OF THE DRAWINGS

FIG. 1 shows a block diagram of the inventive decompress process according to an exemplary embodiment of the present invention.

FIG. 2 shows an example of an original audio track from a commercial recording according to an exemplary embodiment of the present invention.

FIG. 3 shows a graph of an original audio after the 48% normalization according to an exemplary embodiment of the present invention.

FIG. 4 shows a graph of an audio wave after the application of the inventive decompress process according to an exemplary embodiment of the present invention.

FIG. 5 shows the De-Compress GUI according to an exemplary embodiment of the present invention.

### DETAILED DESCRIPTION OF THE PREFERRED EMBODIMENT(S)

In one exemplary embodiment the inventive audio De-Compress technique is a VST effect plug-in for use with audio editing programs that edit audio and support VST. The inventive plug-in can replace dynamic and harmonic content in overly compressed files, such as Dance Music. Some exemplary applications for this technique include remixing of existing music, internet broadcast, terrestrial broadcast, or anything audio that needs to have the harmonic and dynamic ranges restored.

The audio signal can first be normalized, for example to about 48%, this equates to about 6 dB when finished [Range 0 to 100%]. The audio signal will be converted to a higher bit rate, for example from 16 bit to 32 bit for increased dynamic range. The audio signal is then processed with the Chebyshev or similar filter. The processed audio can then be converted back to a 16 bit. The audio is then processed with dithering.

Details of the present invention are now described with reference to the drawings.

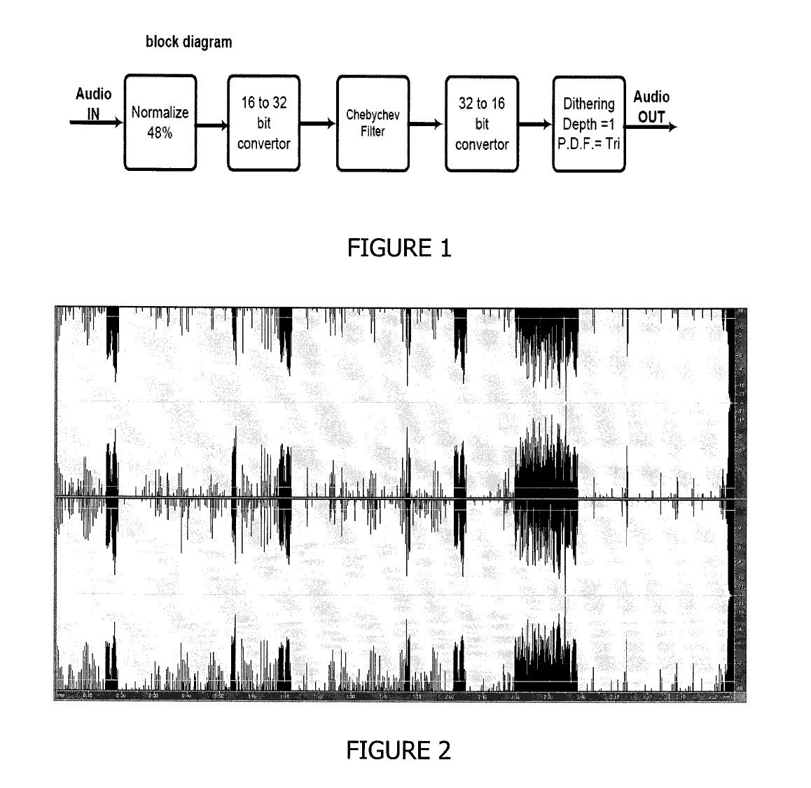

FIG. 1 shows a block diagram of the inventive method. First, the over compressed audio is normalized at a percentage of 48. Next, the audio is converted from 16 to 32 bit to allow the filter a better resolution source to process. The next step is processing with a Chebyshev (or similar) filter with a range of 4 Hz to 22050 Hz (bandpass mode) at the order of 18 (@36 dB estimated). (This step will resynthesize, or recreate the harmonic and dynamic information that was lost due to excessive audio compression.) After the filter, the audio is converted back to 16 bit with the dither setting shown in the block. The end result is a newly repaired piece of audio with the dynamic and harmonic content restored.

FIG. 2 shows an example of the sound waves from an original audio track of a commercial recording.

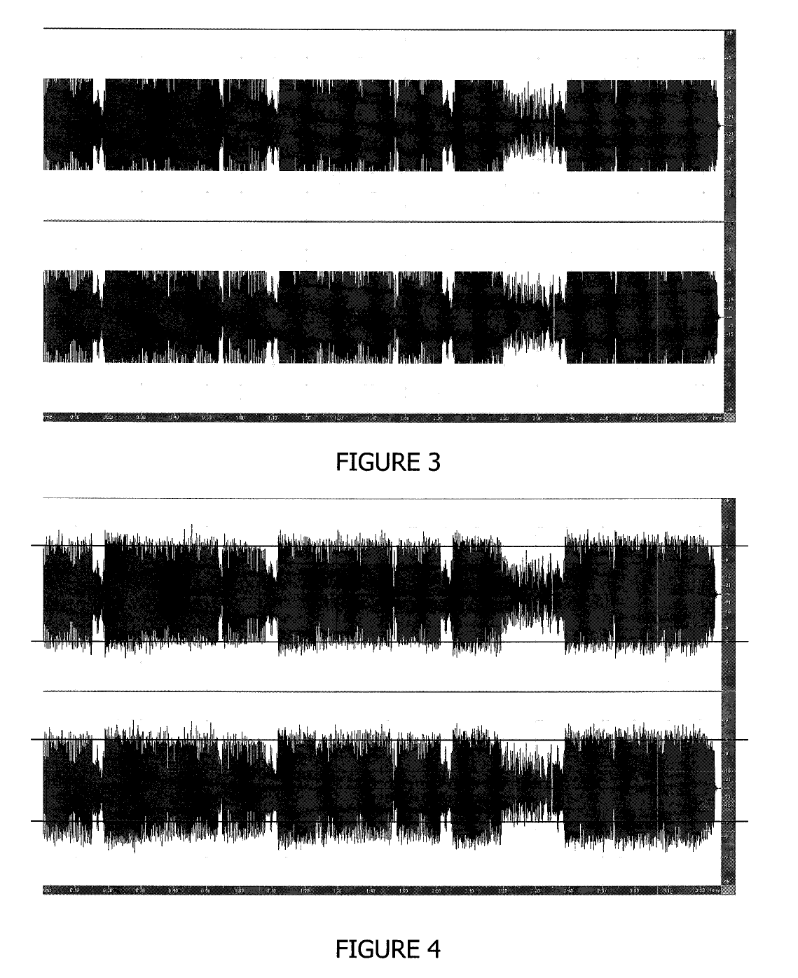

FIG. 3 shows the original audio after it has undergone the 48% normalization process.

FIG. 4 shows the audio sound wave after its has undergone the inventive De-compress process of the present invention.

One skilled in the art would appreciate that everything outside of the two red lines on the waveform picture in FIG. 4 correspond to resynthesized audio. As shown in FIG. 4, both the harmonic and dynamic ranges have been increased proportionally. At this point, one can edit the audio content using whatever tool is necessary (EQ, Delay, Compression, etc.) with auditory results that could not be achieved without first applying the inventive process.

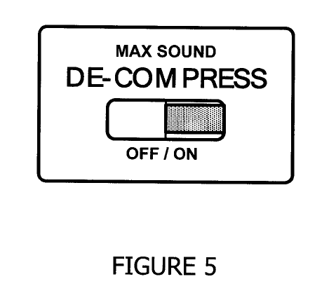

FIG. 5 shows a GUI of the inventive De-Compress method according to an exemplary embodiment of the present invention.

What is claimed is:

1. An audio enhancement technique comprising:
An audio source;
Normalize the audio source at a percentage of 48.
Converting the normalized audio source from 16 to 32 bit;
Processing the normalized audio source with a Chebyshev filter
Converting the filtered audio back to 16 bit with the dither setting shown in the block.

2. The technique of claim 1, wherein Chebyshev filter has a range of 4 Hz to 22050 Hz (bandpass mode) at the order of 18 (@36 dB estimated).
